(19) United States
(12) Patent Application Publication
(10) Pub. No.: US 2008/0169007 A1
(43) Pub. Date: Jul. 17, 2008

(54) APPARATUS AND METHOD FOR PROCESSING A HYDROPHOBIC SURFACE OF A SUBSTRATE

(76) Inventors: Ismail Kashkoush, Orefield, PA (US); Gim-Syang Chen, Allentown, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/755,619

(22) Filed: May 30, 2007

Related U.S. Application Data
(60) Provisional application No. 60/809,656, filed on May 30, 2006.
(60) Provisional application No. 60/831,793, filed on Jul. 19, 2006.
(60) Provisional application No. 60/844,859, filed on Sep. 15, 2006.

(51) Int. Cl. B08B 3/04; B08B 13/00

(52) U.S. Cl. 134/28; 134/157

(57) ABSTRACT

A method of processing a substrate comprising a) supporting a substrate having a hydrophilic surface in a substantially horizontal orientation, b) rotating the substrate, c) applying a film of an aqueous solution of HF to the hydrophilic surface of the substrate for a period of time sufficient to convert the hydrophilic surface into a hydrophobic surface, wherein the concentration of HF is between about 0.1% to about 0.5% by weight of HF in water and the period of time is between about 100 and about 300 seconds, d) applying DI water to the hydrophobic surface of the substrate, and e) applying a drying fluid to the hydrophobic surface of the substrate so as to substantially dry the hydrophobic surface. The invention also is an apparatus for processing a substrate comprising a chamber having at least one wall, a rotary support member located within the chamber for supporting the substrate in a substantially horizontal position and adapted to rotate the substrate, and a first exhaust exit located within the at least one wall, wherein the first exhaust exit is tangential to a rotational direction of the substrate.

### CROSS-REFERENCE TO RELATED PATENT APPLICATIONS

This application claims the benefit of U.S. Provisional Application No. 60/809,656 filed on May 30, 2006; U.S. Provisional Application No. 60/831,793 filed July 19, 2006; and U.S. Provisional Application No. 60/844,859 filed Sep. 15, 2006, the entireties of which are hereby incorporated by reference.

### FIELD OF INVENTION

The present invention relates generally to the field of processing substrates, and specifically to methods and apparatus for rinsing and/or drying hydrophobic surfaces of semiconductor wafers.

### BACKGROUND OF THE INVENTION

The importance of clean semiconductor wafer surfaces in the fabrication of semiconductor devices has been recognized since the beginning of the industry. Failing to removes trace impurities, such as sodium ions, metals, and particles, from a semiconductor wafer surface is known to be especially detrimental during high-temperature processing because the impurities tend to spread out and diffuse into the semiconductor wafer, thereby altering the electrical characteristics of the semiconductor devices formed in the wafer. Altering a semiconductor device's electrical characteristics causes the device to fail and, therefore, subtracts from a wafer's yield. The inadequate and/or improper drying of a semiconductor wafer surface is also known to negatively affect a wafer's yield. Over time, as VLSI and ULSI silicon circuit technology has developed, the cleaning and drying processes have become particularly critical steps in the semiconductor fabrication process.

In order to minimize device failure, semiconductor wafers are typically subjected to a multitude of intermediate cleaning and drying steps between the various manufacturing steps required for semiconductor device fabrication. Thus, the integrity, efficiency and effectiveness of the cleaning (and subsequent drying) step has become extremely important for the successful manufacture of semiconductor devices.

Of particular importance are cleaning and drying applications that are performed after the application of hydrogen fluoride or hydrofluoric acid (HF) to the surface of a wafer. Traditionally, cleaning and drying processes performed subsequent to HF-last processes result in less than optimal particle removal and the creation of watermarks on the wafer surface. For example, post-clean light-point defects (LPD) have been observed totaling 20 LPD at >0.12 μm and 900° C. low temperature bake post-epitaxial LPD have been observed totaling 158 LPD at >0.12 μm.

It is believed that the difficulties with cleaning and drying semiconductor wafers after HF-last processes results from the surface of the semiconductor wafers becoming hydrophobic in nature from the application of HF. Specifically, it is the transition of the wafer surface from hydrophilic to hydrophobic in nature that causes the undesired particle addition and the creation of watermarks on the surface. The application of HF, however, is necessary to prepare the surface of the semiconductor wafer to certain manufacturing steps, such as thin film deposition processes (e.g., the deposition of epitaxial silicon). Proper pre-epitaxial cleaning and drying processes are also critical in that they remove unwanted oxides from the surfaces of wafers prior to film deposition. The problems experienced from inadequately cleaning and drying of the surfaces of semiconductor wafers subjected to an HF-last process have become even more exasperated by the transition of the semiconductor industry from batch immersion platforms to single-wafer spin processing platforms.

Single-wafer cleaning and drying technology has gained increasing attention in the semiconductor manufacturing industry due to its advantages in cycle time, flexibility, and cost-of-ownership in fabrication operations. An example of such a system is disclosed in U.S. Pat. No. 6,039,059 to Bran, the entirety of which is herein incorporated by reference. While many of the theories and fundamental concepts for the wet processing of wafers remain similar for both platforms, the change from batch immersion platforms to single-wafer spin processing tools has led to challenges in some applications. One such application is that of the cleaning and drying of semiconductor wafers subjected to an HF-last process. In fact, the subsequent cleaning and drying of wafers subjected to HF-last process has proven to be one of the most problematic areas for single-wafer spin processing tools, often resulting in high particle counts and the creation of watermarks on the wafer. Thus there is a need for an improved cleaning and/or drying process that can be performed on a single-wafer spin processing tool for semiconductor wafer surfaces that have been subjected to an HF-last process.

### SUMMARY OF THE INVENTION

These problems and others are solved by the present invention which in one aspect is a method of processing a substrate comprising a) supporting a substrate having a hydrophilic surface in a substantially horizontal orientation, b) rotating the substrate, c) applying a film of an aqueous solution of HF to the hydrophilic surface of the substrate for a period of time sufficient to convert the hydrophilic surface into a hydrophobic surface, wherein the concentration of HF is between about 0.1% to about 0.5% by weight of HF in water and the period of time is between about 100 and about 300 seconds, d) applying DI water to the hydrophobic surface of the substrate, and e) applying a drying fluid to the hydrophobic surface of the substrate so as to substantially dry the hydrophobic surface.

A further aspect of the invention can be a method of processing a substrate comprising a) supporting a substrate having a hydrophilic surface in a substantially horizontal orientation, b) rotating the substrate about a center point at a rotational speed selected to minimize particle addition on the substrate, c) applying a film of an aqueous solution of HF having a concentration of HF to the hydrophobic surface of the substrate for a period of time, wherein the concentration of HF and the period of time are selected so that the hydrophilic surface is converted into a hydrophobic surface, d) applying DI water to the hydrophobic surface of the substrate, and e) applying a drying fluid to the hydrophobic surface of the substrate so as to substantially dry the hydrophobic surface, the drying fluid coupled to a drying source comprising a first bubbler and a second bubbler, wherein the second bubbler is sequentially and operably aligned to the first bubbler, the first bubbler generating N₂/IPA vapor having a first IPA concentration and coupled to the second bubbler, the second bubbler generating N₂/IPA vapor having an elevated IPA concentration greater than the first IPA concentration, and wherein the drying fluid comprises the elevated IPA concentration.

Yet another aspect of the invention can be an apparatus for processing a substrate comprising a chamber having at least one wall; a rotary support member located within the chamber for supporting the substrate in a substantially horizontal position and adapted to rotate the substrate; and a first exhaust exit located within the at least one wall, wherein the first exhaust exit is tangential to a rotational direction of the substrate.

### BRIEF DESCRIPTION OF DRAWINGS

FIG. 1 is a schematic of the cleaning and processing system according to an embodiment of the present invention.

FIG. 2 is a chart illustrating the effect of etch time at different HF concentrations on substrate particle addition.

FIG. 3 is a graph of etch time v. normalized oxide thickness for the application of two different aqueous solutions having different HF concentrations to a silicon wafer.

FIG. 4 is a chart showing the effect of etch time on substrate particle addition as well as native oxide thickness.

FIG. 5 is a chart illustrating the effect of gases-aerated DIW on substrate particle addition.

FIG. 6 is a chart showing the effect of varying rotational speed with a 60 second rinse on substrate particle addition for multiple embodiments of the present invention.

FIG. 7 is a graph comparing the addition of particles on a wafer surface when subjected to a DIW rinse as opposed to an aqueous HF solution rinse.

FIG. 8 is a chart illustrating the effect of varying rotational speed on substrate particle addition.

FIG. 9 is a chart illustrating the effect of DIW rinse time at 60 seconds and 5 seconds on substrate particle addition.

FIG. 10 is a chart illustrating the effect of a substrate final spin on particle addition, the final spin conducted within a process chamber with a standard exhaust system.

FIG. 11 is a chart illustrating the effect of the lack of a substrate final spin on particle addition, the substrate contained within a process chamber with a standard exhaust system.

FIG. 12a is a simplified top view of the process chamber with connected standard exhaust.

FIG. 12b is a simplified side view of the process chamber with connected standard exhaust.

FIG. 13a is a simplified side view of the process chamber with a tangential exhaust exit.

FIG. 13b is a simplified top view of the process chamber with a tangential exhaust exit and a standard exhaust exit.

FIG. 13c is a simplified top view of the process chamber with two tangential exhaust exits.

FIG. 14 is a chart illustrating the effect of a substrate final spin on particle additions, the final spin conducted within a process chamber with a tangential exhaust exit and a standard exhaust exit.

FIG. 15 is a chart illustrating the effect of a substrate final spin on particle additions, the final spin conducted within a process chamber with two tangential exhaust exits.

FIG. 16 is a chart illustrating the effect of a substrate final spin on particle additions, the final spin conducted within a process chamber with a −0.5 in standard exhaust without baffles and a reference air velocity of approximately 206 fpm.

FIG. 17 is a chart illustrating the effect of a substrate final spin on particle additions, the final spin conducted within a process chamber with a −1.04 in standard exhaust without baffles and a reference air velocity of approximately 150 fpm.

FIG. 18 is a graph of the airflow velocity achieved by chamber exhaust v. particle addition for HF-last processes.

FIG. 19 is a chart illustrating the effect of IPA concentration using a single canister versus a dual canister for varying etch times on substrate particle addition.

### DETAILED DESCRIPTION

The preferred embodiments will be illustrated with reference to the drawings. Various other embodiments should become readily apparent from this description to those skilled in the art.

The present invention generally relates to HF-last cleaning processes, which can be used in many applications including but not limited to Pre Gate, pre EPi/SiGe, pre-metal deposition and the like. In such applications, it is important to minimize impurities and contaminants deposited on the surface of the substrate or wafer, which alter the electrical characteristics of a wafer and can lower a wafer's yield. High counts of particles and watermarks are typically seen using the HF-last process when implemented with single wafer spin applications. Accordingly, it has been discovered that the environment in which the wafers are processed has shown to be the key factor in preventing watermarks and particle addition in single wafer spin applications.

For example, it has been discovered that low oxygen content on the substrate surface as well as uniform etching is important to the prevention of cleaning defects (which can include but are not limited to particles added to the substrate surface during cleaning). There is a positive correlation between the number of defects on the substrate surface during the cleaning process and the number of defects on the substrate post deposition. Low or no metal contamination on the substrate surface is also important in preventing cleaning and post deposition defects.

Experiments were conducted on a one-chamber single wafer module to determine the key factors of the processing environment for controlling particulate contamination on HF-processed wafers. The test module was capable of processing 200 and 300 mm wafers with variable rotational speeds, chemical concentrations and spin or IPA vapor drying.

In processing wafers, variables such as rotational speed, chemical concentration, and IPA (isopropyl alcohol) vapor concentration, among others, can be adjusted as desired. Wafers were conditioned in a standard cleaning step (“SC1 step”) first before running the processes of the present invention, including the HF-last process. Such a standard cleaning step is not necessary, however, and the processes of the present invention can be implemented absent such a SC1 step. Wafers were processed in the single wafer tool and the following parameters, among others, were investigated: HF concentration, etching time at a given concentration of HF, DI (de-ionized) water rinse time, IPA vapor concentration, rotational speed during rinse and dry, airflow characteristics and gas content in the rinse water. Before running the experiments, P-type bare silicon wafers were first conditioned with SC1 megasonic cleaning in a batch immersion bench. An Applied Materials Excite system for particle evaluation was used to inspect the wafers before and after testing. Typical pre-counts of the testing wafers were less than 20 particles for 100 mm wafers (less than 50 for 300 mm wafers) at greater than or equal to 100 nm with 3 mm edge exclusion. De-ionized water (“DIW” or “DI water”) was degasified with a membrane degasifier operated without N₂ sweeping. Dissolved oxygen, solids and TOC levels in the DIW were generally kept below 1 ppb. The N₂ and CO₂ content in the DIW was 3 ppm and 0 ppm, respectively, as measured by an Orbisphere 3620 gas analyzer. During the experiments evaluating dissolved gas effects, a membrane aerator was used to deliver the gas of interest into the DIW before the single wafer module. During some experiments, chemical HF was drawn from a reservoir and injected into the DIW supply stream and blended by an in-line static mixer.

The concentration of HF and IPA vapor was discovered to be key factors in achieving satisfactory particle performance. The degree of hydrophobicity, as measured by the combination of HF concentration and etch time was found to be a factor for producing low particle counts on wafers. The experiments showed that the rotational speed during the rinsing step also has significant effects on particle results. Finally, it was also discovered that excessive dissolved gases in rinse water and improper chamber airflow negatively impact particulate performance for HF-last processes. The experimentation of each of the aforementioned factors will be discussed in greater detail below.

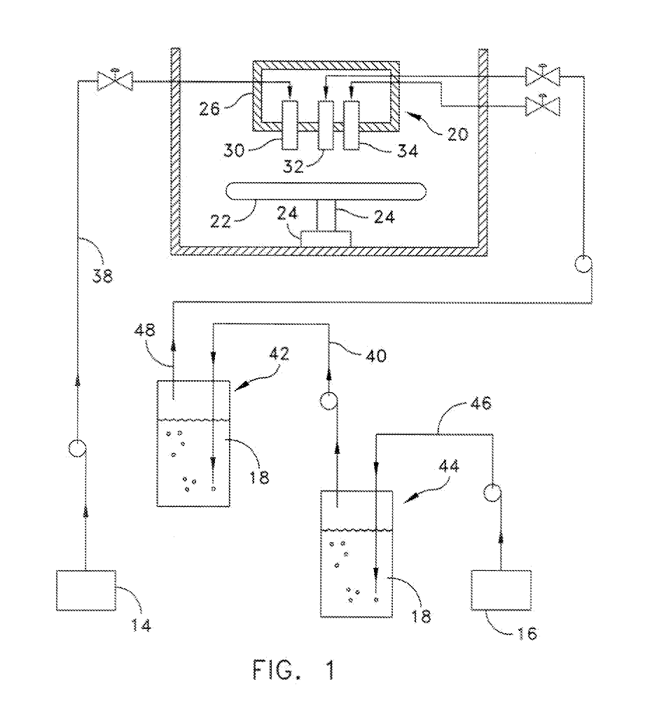

The system in which the process of the present invention is utilized, however, will now be described. Referring to FIG. 1, the system of the present invention comprises a process chamber 10, a rotary support 12, a DIW source 14, and an IPA source 18. In some preferred embodiments, the system of the present invention can further comprise a nitrogen reservoir 16, which can be used to supply nitrogen gas to the chamber 10. Nitrogen gas can also be supplied into and mixed with IPA from an IPA source 18. The system of the present invention can also further comprise an assembly 20 positioned above the substrate 22. The rotary support 12 is positioned within the process chamber 10 and is adapted to support the substrate 22 in a substantially horizontal orientation. Preferably, the rotary support 12 contacts and engages only the perimeter of the substrate in performing its support function. The rotary support 12 is operably coupled to a motor 24 to facilitate rotation of the substrate within the horizontal plane of support. The motor 24 is preferably a variable speed motor that can rotate the support 12 at any desired rotational speed. Optionally, the motor 24 is electrically and operably coupled to the controller (not shown). The controller controls the operation of the motor 24, ensuring that the desired rotational speed and desired duration of rotation are achieved.

In a preferred embodiment, the assembly 20 is mounted within the process chamber 10 so as to be positioned closely to and above the surface of the substrate 22 positioned on the support 12. The assembly 20 can comprise a housing 26 that holds a DIW dispensing nozzle 30, a first IPA dispensing nozzle 32, and a second IPA dispensing nozzle 34. Optionally, the IPA dispensing nozzles 32, 34 can be N₂/IPA dispensing nozzles. The DIW dispensing nozzle 30 and the IPA dispensing nozzles 32, 34 are operably and fluidly coupled to the DIW source 14 and the IPA source 18, respectively. In another embodiment, a rinse dispensing nozzle (not shown) can be fluidly and operably coupled to the DIW source. The rinse dispensing nozzle need not be connected to the assembly 20 and may be separate from the assembly 20.

The housing 26 can be mounted above the substrate in a variety of ways, none of which are limiting of the present invention. The assembly 20 can be translated/moved above the substrate 22 in a generally horizontal direction so that the DIW dispensing nozzle 30 and the IPA dispensing nozzles 32, 34 can be moved from a position above the center of the substrate 22 to a position beyond the edge of the substrate 22, as more fully disclosed in U.S. patent application Ser. No. 11/624,445 entitled “System and Methods for Drying a Rotating Substrate,” the teachings of which are hereby incorporated by reference.

In applying the HF-last cleaning process according to one embodiment of the present invention, the substrate 22 is first supported in a substantially horizontal position and then rotated about a rotational center point, while housed within the processing chamber 10. In one embodiment, the processing chamber 10 substantially contains nitrogen gas, meaning the processing chamber 10 is a nitrogen-rich chamber. The effect of a nitrogen-rich chamber is to prevent oxygen or oxygen radicals from oxidizing silicone, which would have the effect of leaving watermarks, particles and the like on the substrate surface.

The substrate is rotated at a constant speed selected to minimize particle addition to the substrate surface. A film of an aqueous solution of diluted hydrofluoric acid can then be applied to the substrate 22 to etch the substrate 22 surface. The diluted hydrofluoric acid solution can be of varying concentrations. The application of a film of diluted hydrofluoric acid is then followed by applying a film of DIW to generally rinse the etching chemicals and/or contaminants from the wafer surface. The film of DIW can be applied to the substrate surface for any desired time period that would minimize particle addition. Although the DIW need not necessarily be degassed in order to practice the present invention, in one embodiment, the DIW is degassed prior to applying the DIW to the substrate surface. The DIW can be degassed at any desired point on the DIW supply line 38 at the DIW source 14. The substrate surface is then dried using a drying fluid used in conjunction with the assembly 20.

Thus, for single wafer spin applications utilizing cleaning and processing steps as described above, it has been discovered that environment factors through which the wafers are processed is important in preventing watermarks and particle addition. Such environmental factors, as described in greater detail below, can be implemented independently or in combination with one or more other environmental factors to minimize particle addition.

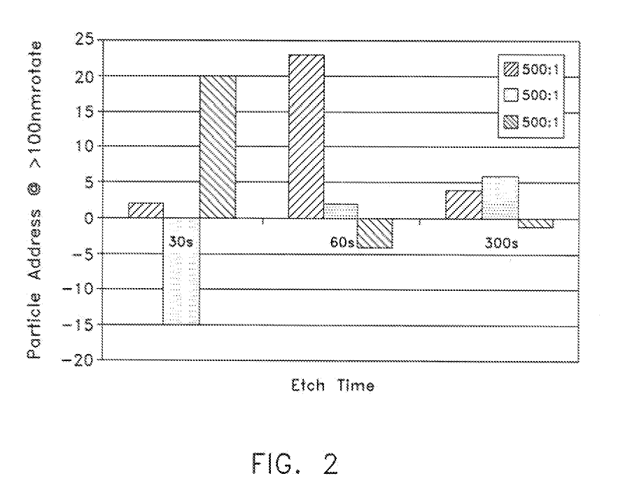

Referring to FIG. 2, experiments show the effect of etch time at different HF concentrations (at approximately 25 degrees Celsius, with soft DIW rinse and utilizing dual IPA bubblers) on substrate particle addition greater than 100 nm. With respect HF-processed wafers for a single wafer spin, the concentration of HF is important in achieving low particle counts on the substrate surface. Specifically, lower concentrations of HF used in the HF-last process in creating a substantially hydrophobic surface produced wafer surfaces with relatively low particle counts. To achieve such a result, it is preferred that the HF solution have a concentration of about 0.1% to 5% by weight of HF in water. More preferably, the HF solution should have a concentration of about 0.1% to 0.5% by weight of HF in water. It was observed that a 30 second etch time produced widely varying results, where an HF concentration of 200:1 (˜0.4% by weight of HF in water) produced a particle addition of −15 particles, while an HF concentration of 100:1 (˜0.5% by weight of HF in water) produced a particle addition of 20 particles. On the contrary, it was observed that for a 300 second etch time, the particle addition dispersion did not fluctuate as wildly as with shorter etch times. The particle addition at 300 seconds remained at a consistently low level. Specifically, at 300 seconds, an HF concentration of 100:1 (˜0.5% by weight of HF in water) produced a particle addition of −1 particle, an HF concentration of 200:1 (˜0.4% by weight of HF in water) produced a particle addition of 6 particles, and an HF concentration of 500:1 (˜0.1% by weight of HF in water) produced a particle addition of 4 particles.

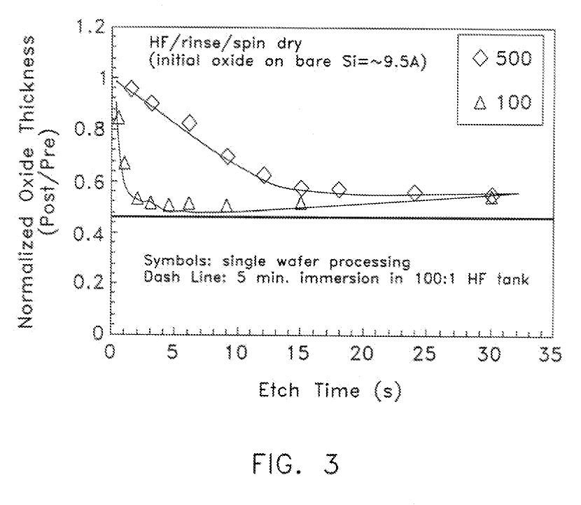

Referring to FIG. 3, the residual oxide thickness on bare Si is shown as a function of etch time. Two aqueous solutions having different HF concentrations were used. The more concentrated aqueous HF solution, 100:1 (DIW:HF) is shown by the triangle shaped data points. The other aqueous HF solution, 500:1, is depicted by the solid diamond shaped data points. In the early stage of etching, the wafers are hydrophilic so that HF solution can fully cover the entire surface. When the wafers become hydrophobic, HF converts into discrete liquid drops that roll on the surface of the wafer. The HF droplets cannot provide full coverage of the wafer. As shown in FIG. 3, applying a more concentrated aqueous HF solution apparently transitions a wafer from the hydrophilic state to the hydrophobic state faster than the less concentrated aqueous HF solution. The remaining oxide, however, seems to increase as the exposure of the Si substrate to the atmosphere is prolonged.

Referring again to FIG. 3, the effect of etching time in HF on resultant particle addition is represented by the solid diamond data points. There has been discovered a range of etch time in which the wafer is most vulnerable to particularly high particle addition. It has been reported that a minimum time is required to remove the native oxide and a monolayer of Si to render the wafer completely hydrophobic. It has been discovered that particle count will depend on the degree of hydrophobicity, as measured by the combination of HF concentration and etch time. The discovery is as follows: For short etch times, shown by the 30 and 80 second processes in FIG. 2, the wafer is still hydrophilic and particle addition is not significant due to the repulsive forces between particles and the native oxide surface. For longer etch times, shown at 120 seconds, the surface state is in the transition from hydrophilic to hydrophobic. Some parts of the wafer surface become hydrophobic before the others because the etching is not uniform. Higher particle deposition depends on the location of the etch by-product particles on the wafer. If the environment and subsequent rinse and dry cycles are controlled properly, the particle addition will decrease when the wafer is over-etched and turns completely hydrophobic. However, prolonged over-etching has been discovered to be undesirable because the chance of particle contamination may increase again.

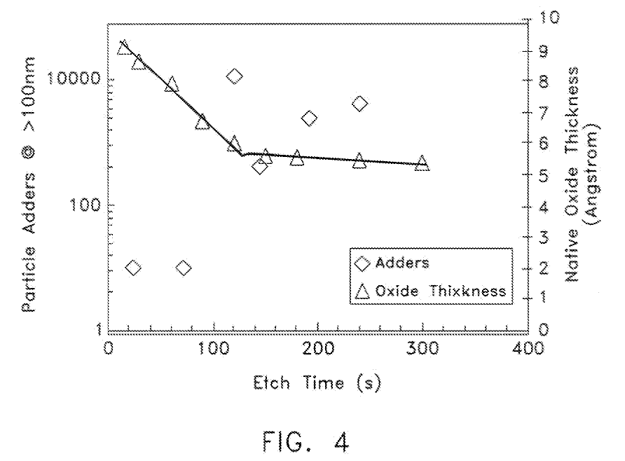

Referring also to FIG. 4, experiments similarly show the effect of etch time on substrate particle addition and native oxide thickness. The experiments in FIG. 4 were conducted with a HF concentration of 500:1 HF at 25 degrees Celsius, with an 800 rpm DIW rinse followed by spin dry. The conversion time at 25 degrees Celsius to make the surface substantially hydrophobic is as follows: for HF concentration of 100:1 the surface conversion time is greater than 45 seconds, for HF concentration of 200:1 the surface conversion time is greater than 90 seconds; for HF concentration of 500:1 the surface conversion time is greater than 200 seconds.

Used in connection with HF concentrations as described herein, it has been observed that a minimum time is required to remove the native oxide and a monolayer of Si to fully render the wafer completely hydrophobic, which assists in the prevention of particle addition. Thus, a longer etch time correlates to lower the particle addition, the long etch time sufficient to cause a substantially hydrophobic substrate surface. In other words, the lower particle counts depend on the degree of “hydrophobicity” of the substrate surface. It believed that such a mechanism works as follows. Wafers are typically hydrophilic prior to the cleaning or processing methods of the present invention. Thus, the wafer surface is negatively charged, which will repulse similarly charged objects, particles or the like. For short etch times, low particle addition is observed on a substrate surface due to the repulsive forces (negative) between negatively-charged particles and wafers surface.

For longer etch times, generally greater than 60 seconds, the surface state transitions from hydrophilic to hydrophobic. Thus, a hydrophobic substrate surface is one that is positively charged. As the surface transitions from hydrophilic to hydrophobic, some parts of the wafer surface become hydrophobic while other parts of the wafer surface remain hydrophilic (due to etch non-uniformity). This transition thereby increases particle counts on the substrate surface because instead of the negatively charged particles being repulsed by a uniformly and negatively charged surface, those negatively charged particles deposit on the positively charged portions of the substrate surface. Likewise, instead of the positively charged particles being repulsed by a uniformly and positively charged surface, those positively charged particle deposit on the negatively charged portions of the substrate surface. Since etch by-products are a mix of negatively charged particles (e.g., SiO₂) and positively charged particles (e.g., Si), the result of such a transition is that the particle count increases on the substrate surface in the interim. As can be observed in FIG. 4, high particle deposition typically takes place depending where these particles are on the wafer.

Once the wafers are over-etched and turn completely hydrophobic, the wafers become positively charged and repel any positively charged particles during the rinse cycle. If the environment is kept so that no aerosols deposit on the wafers during the drying cycle, HF-typically yields very low particle addition. This can be accomplished in a variety of ways, one of which is to maintain a substantially N₂ rich chamber. Referring back to FIG. 2, only 6 particles or less were added at any HF concentration for a long etch time (about 300 seconds). When the environment is not substantially isolated from outside aerosols, however, it has been generally observed that the longer the substrate is processed, the more particles are deposited on the substrate.

Thus, to effectuate a substantially hydrophobic surface, the HF solution has a concentration of about 0.1% to 5% by weight of HF in water, preferably a concentration of about 0.1% to 0.5% by weight of HF in water. The HF solution is supplied to the surface for a period greater than about 60 seconds, and preferably within the range of about 200-400 seconds. To effectuate a substantially hydrophilic surface, the HF solution likewise has a concentration of about 0.1% to 5% by weight of HF in water, preferably a concentration of about 0.1% to 0.5% by weight of HF in water. The HF solution is supplied to the surface for a short period of time, roughly between about 1-45 seconds, preferably about 5-20 seconds.

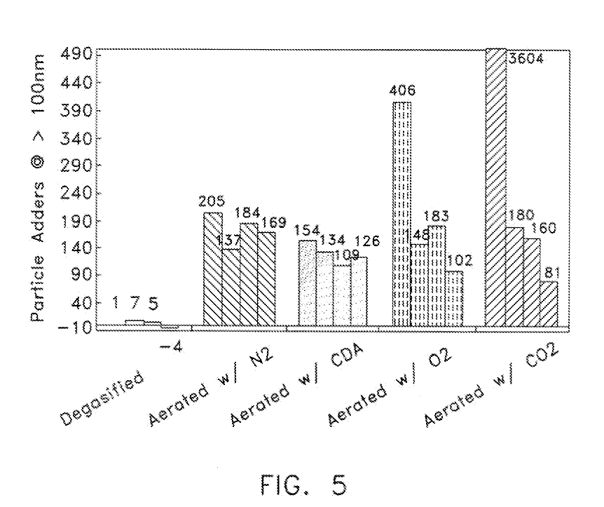

Referring to FIG. 5, experiments show the effect of different dissolved gases in rinse water on substrate particle addition greater than 100 nm. Such experiments were conducted with application of HF (at a concentration of 100:1) for 1 minute at 25 degrees Celsius, followed by a DI water rinse and IPA dry. Gases including N₂, CDA, O₂ and CO₂ were injected to the rinse water to at or over the saturation limit. (Dissolved gasses can also include but are not limited to carbon monoxide, nitric oxide, hydrogen, methane, and the like.) It was previously demonstrated that dissolved N₂ gas at about 20 ppb in water and having an aqueous solution thereof with a low pH (˜pH2-3) could suppress the formation of watermarks (typically known for this process). Many semiconductor fabricators use N₂-purged and -blanketed water to keep O₂ content low to suppress the formation of watermarks. Contrary to industry practice, experiments show that excessive dissolved gas, irrespective of type, in the rinse DIW generates particles on the hydrophobic wafers. In contrast, degasified rinse water produces the lowest level of particle addition. A DIW pressure of 20 psig on one side of the aerator's membrane and a 7 psig of gas input on the other side of the membrane is sufficient to provide the dissolved gas above its saturation limit in the rinse water. Through experimentation, when the DIW was dispensed into a glass beaker, micro-bubbles from the pressure drop were visually observed. Once solids collected at the gas-liquid interface contact the hydrophobic wafer surface, they yield high particle counts.

Specifically, experiments have shown that using DIW aerated with N₂ gas has the effect of adding 205, 137, 184 and 169 particles to the substrate surface. Likewise, DIW aerated with CO₂ gas has the effect of adding 3604, 180, 160 and 81 particles to the substrate surface. Generally, the aeration of gas in DIW correlates to particle addition in excess of at least 150 on average.

It has been found through experimentation, however, that removing dissolved gasses in the DIW correlates to the lowest particle count on the substrate surface. Degasified DIW provided the lowest particles added, wherein the particles added numbered 1, 7, 5 and -4 particles. The reason for the discrepancy in particle addition with respect to degassed DIW compared to DIW injected or aerated with gas, is that at these levels of dissolved gasses, solids collect at the air-liquid interface. Once in contact with the wafers' surface they yield high particles.

Thus, while some gases such as nitrogen are helpful to prevent the formation of watermarks, in utilizing the process of one embodiment of the present invention, the preferred approach is to provide DIW or rinse water that is gas-free and solids-free. In such an embodiment, prior to rinsing the substrate with DIW, substantially all of the gas entrained in the DIW is removed from the DIW. Preferably, and as described previously, the DIW should contain less than 1 ppb of dissolved oxygen and less than 10 ppb of total dissolved gasses. Prior to rinsing the substrate with DIW, the DIW can be filtered through a filtration system, including but not limited to a point-of-use (POU) filtration system. Preferably, the POU filtration has a pore rating of about 0.01 to about 0.03 μm.

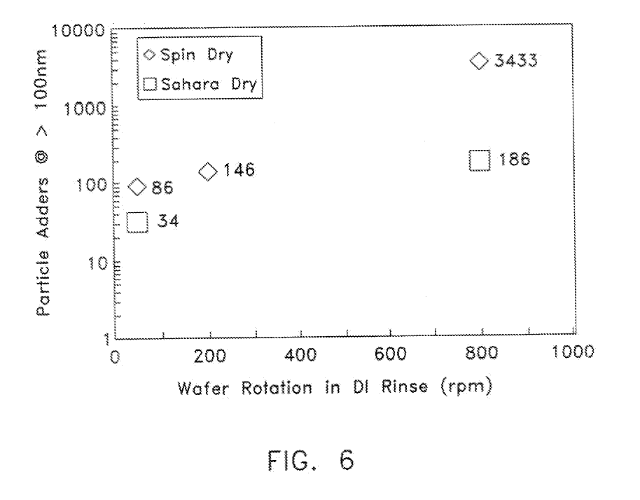

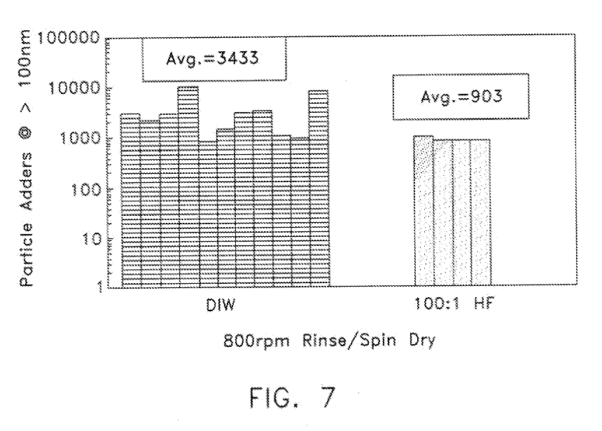

Referring now to FIG. 6, the effect of the rotational speed during the DIW rinse cycle (60 seconds) on the particle performance of hydrophobic wafers for two different drying methods is illustrated. As can be seen from the data, the spin drying method results in higher particle addition the IPA drying method. The effect of spin drying is depicted by the solid diamond shaped data points, and IPA drying is shown by the square data points. With its low surface tension, IPA displaces the DIW from the wafer surface and thereby captures more water droplets than does spin drying. When the water droplets are left to evaporate on the wafer surface, non-volatile silicic acid (H₂SiO₃), which results from the reaction between silicon and dissolved O₂, precipitates to form particles. The particle mapping of FIG. 6 also shows that the particle addition increases with increased rotational speed during the rinse step, forming star-bursting like streak patterns. It was discovered that at high rotational speeds, highly insulating DIW sheers across the Si surface, creating high levels of static charge that increases the particle deposition. In addition, high speed spinning decreases the water boundary by creating smaller droplets and thus enhances O₂ absorption by diffusion, thereby leading to higher silicate concentrations in individual droplets. Small droplets easily evaporate prematurely, thus leaving particles on the wafer. Rinsing with a conductive solution such as 100:1 DIW:HF, however, with the same high rotational speed has led to the disappearance of the streak patterns and lesser particle adders. The difference in particle results between using a pure DIW rinse and 100:1 DIW:HF rinse is shown in FIG. 7.

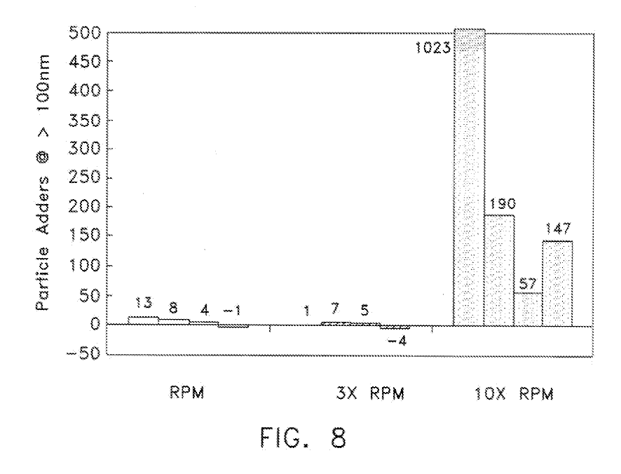

Is has also been observed that a lower rotational speed during the cleaning and processing steps of the present invention correlates to lower particle counts on the wafer surface. Experiments were conducted with application of HF (at a concentration of 100:1) for 1 minute at 25 degrees Celsius, followed by a DI water rinse and IPA dry. As seen in FIG. 8, a rotational speed of 100 rpm (RPM) produced particle additions of 12, 8, 4 and -1 particles, while a rotational speed of 300 rpm (3× RPM) particle additions of 1, 7, 5 and -4 particles. At rotational speeds generally higher than 600 RPM, however, a trend of higher addition of particles is observed with increasing rotational speed. A rotational speed of 1000 rpm (10× RPM) produced particle additions of 1023, 190, 57 and 147 particles. At higher rotational speeds, it is believed that the water boundary layer is decreased and the potential for gas absorption by diffusion is higher. (Referring back to FIG. 5, experimentation shows that the higher the gas content in the DIW, the higher the particle counts on the substrate surface.) Also, at higher speeds the concentration of solids per unit volume is higher (due to the thinning of liquid layer at higher speeds) which results in higher residual particles on the wafer surface at the end of the cycle. Thus, in a preferred embodiment, the rotational speed during the rinsing and drying step is kept constant at a speed in the range below 400 rotations per minute (rpm), preferably between about 1-200 rpm.

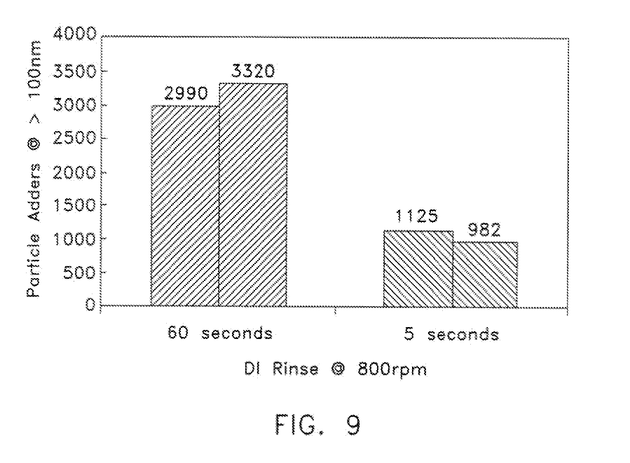

Referring to FIG. 9, experiments show the effect of DIW rinse time at 60 seconds and 5 seconds on particle addition, which were conducted on hydrophobic substrates prior to a spin dry. It has been discovered that a shorter DIW rinse time correlated to a lower particle count on the substrate surface. As seen in FIG. 9, a rinse time (at a constant rotational speed of 800 rpm) of 5 seconds produced particle additions of 1125 and 982 particles. On the contrary, a longer rinse time (at a constant rotational speed of 800 rpm) of 60 seconds produced particle additions of 2990 and 3320 particles. Thus, at lower rinse times, a lower total volume of DIW is applied to the substrate surface, which translates into a lower total number of particles that are added to the substrate surface. The rinse time, however, needs to be sufficient for effective rinsing of the HF solution from the substrate surface. In one embodiment, the DIW rinse time is between about 1-60 seconds. In a preferred embodiment, the DIW rinse time is between about 5-20 seconds.

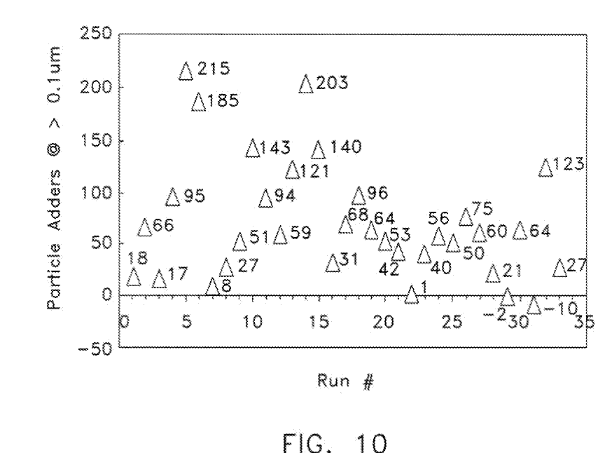

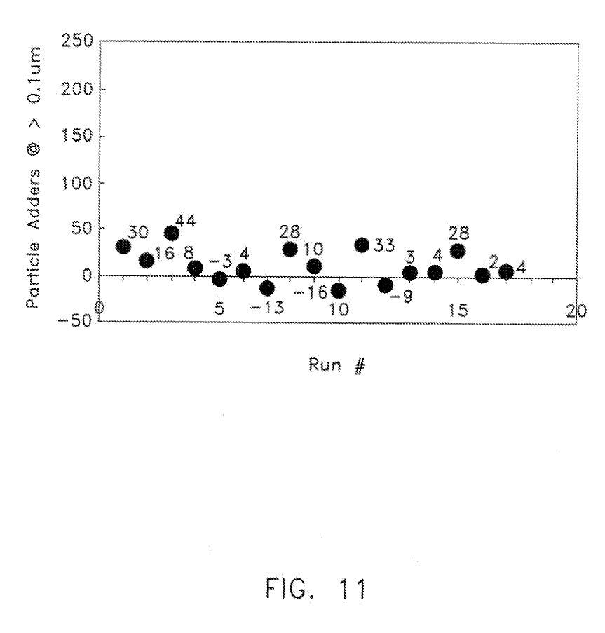

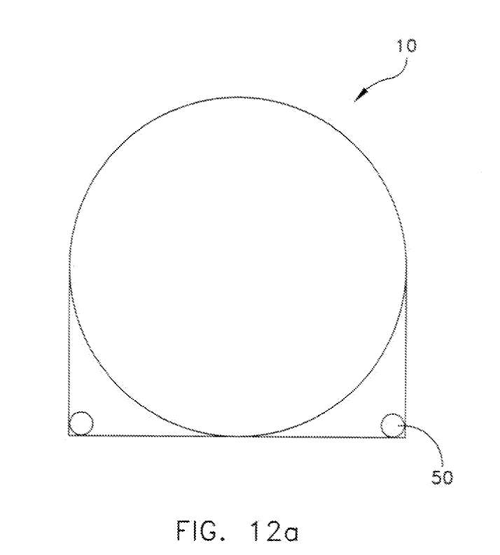

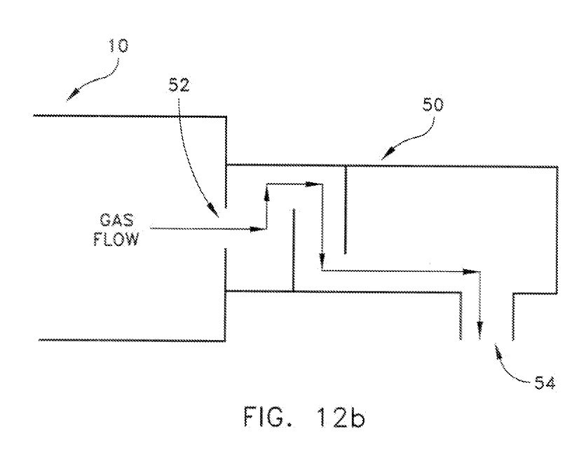

After the DIW rinse step, a spin step may optionally be performed at a high rpm in one embodiment. It is understood, however, that the spin step may be conducted at a low rpm less than 500 rpm, which in some embodiments of the present invention, is preferred. As shown in FIG. 10, experiments show the effects of a high rpm final spin step in the process chamber 10 with an axial or down flow exit standard exhaust 50, which will be discussed in greater detail below and in FIGS. 12a and 12b. Generally, the rpm spin step is performed after the application of an aqueous solution of HF followed by a DIW rinse step. The high rpm can be any rpm greater than 500 rpm; however, it is preferred that that the high rpm be greater than 1000 rpm. Such a high RPM final spin produced particle additions on a wafer surface ranging from approximately 20 to 150 particles additions per run. As shown in FIG. 11, additional experiments show the effects of particle additions on a wafer surface without a high RPM final spin, likewise conducted within the process chamber 10 with a standard axial or down flow exit exhaust 50. From FIG. 11, the particle additions ranged from approximately −10 to 40, where a high RPM final spin was applied to the wafer (which is less than the approximate range as shown in FIG. 10). Thus, in one embodiment, it is preferred to not apply a high RPM final spin to the wafer.

In an alternative embodiment, a final spin step after the DIW rinse step is desirable. In such an embodiment, the (spinning) wafer surface becomes exposed to a gas supplied to and/or present within the process chamber 10. It has been discovered through experimentation that the wafer surface is very sensitive to air movement and gas pressure buildup in the process chamber 10. As will be discussed below, the greater the buildup of pressure the greater the addition of particles on the wafer surface. The buildup of pressure from gas supplied to the process chamber 10 can be caused by high system impedance that does not allow gas to exit the process chamber 10 quickly enough, at the right time, or at the right direction. Referring to FIGS. 12a and 12b, the configuration of the (down flow exit) standard exhaust 50, which is operably connected to the process chamber 10 at opening 52, is shown. The standard exhaust set-up is a −0.35 inches. An area within the standard exhaust 50 is composed of a plurality of baffles that direct or bend the flow of gas to standard exit 54. Such air flow is characterized as axial or down flow exit.

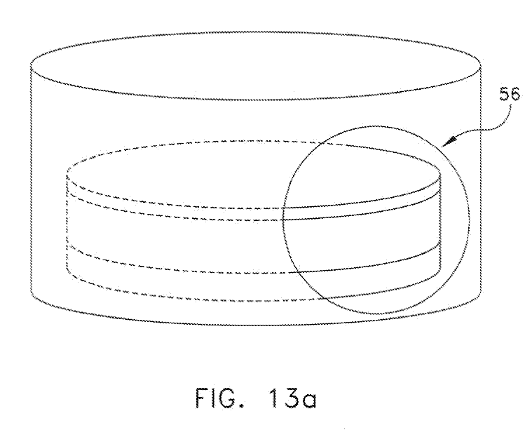

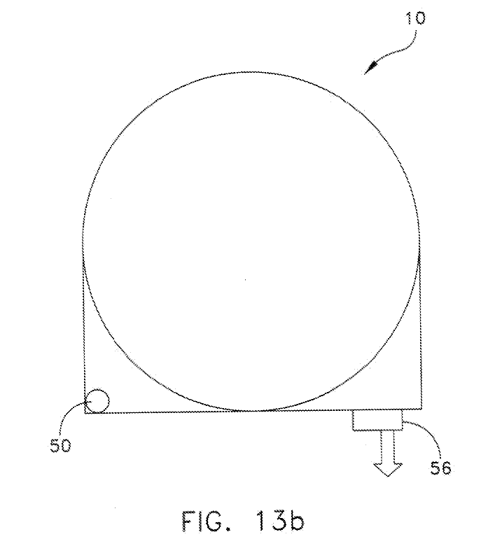

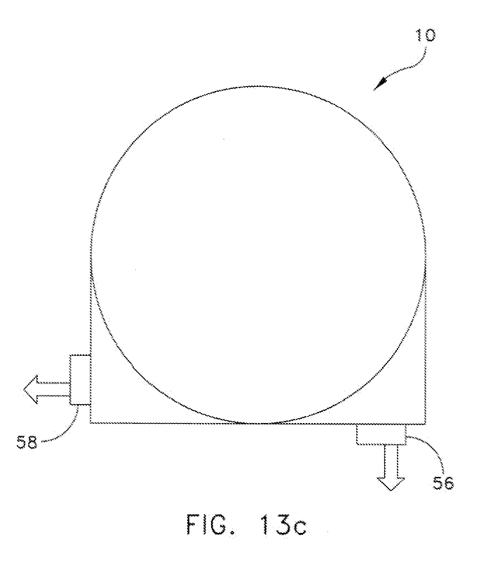

As shown in FIGS. 13a and 13b, one embodiment of the process chamber 10 having an improved exhaust system is shown. As shown in FIG. 13b, the air flows through one tangential gas exit 56 in a tangential direction relative to the spinning wafer. The process chamber 10 having an improved exhaust system can also be comprised of two tangential gas exits 56, 58, as shown in FIG. 13c. Such an improved exhaust system (whether having a single gas exit or multiple gas exits) provides for substantially tangential and/or horizontal gas exit(s) with no bends to the air flow. This aids in preventing gas pressure buildup in the process chamber 10, which contributes to a lower system impedance as there are no bends to inhibit flow of the gas through the gas exit.

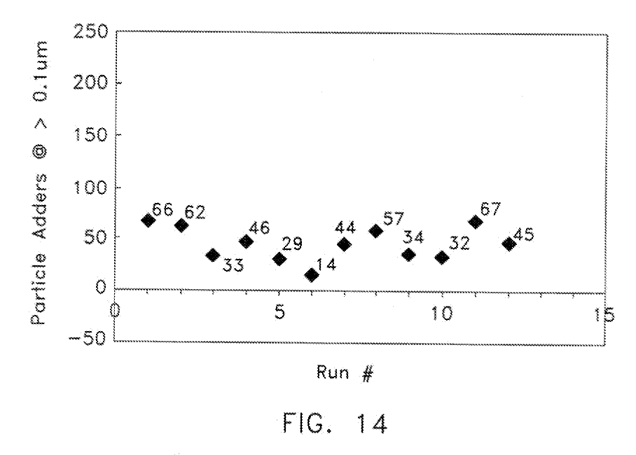

As shown in FIG. 14, experiments show particle additions on a wafer surface in conjunction with a final spin after a modification of the chamber 10 to include one tangential airflow exit and one axial (down flow) exit, where the exhaust set up was at −0.3 inches. Referring back to FIG. 13b, the modification is such that the process chamber 10 is operably connected to a standard down flow exit exhaust 50 and a tangential gas exit 56. Experiments show that the air flow inside of the process chamber 10 was three-dimensional and the reference air velocity within the process chamber 10 was approximately 208 FPM (feet per minute). The approximate particle addition was 44 particles (greater than 0.1 um) per run, and ranged from about 12 particle additions to about 67 particle additions.

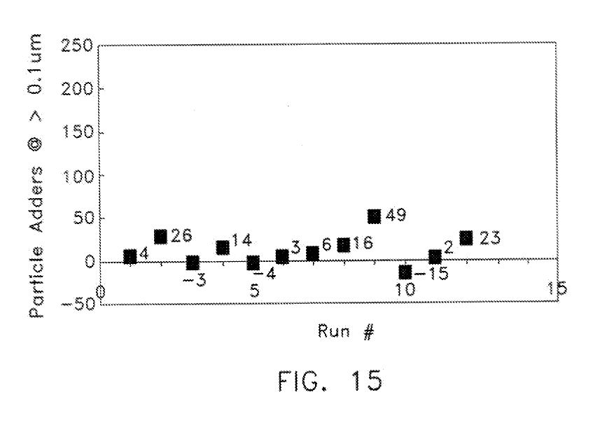

As shown in FIG. 15, experiments show particle additions on a wafer surface in conjunction with a final spin after a second chamber modification. In the second chamber modification, referring back to FIG. 13c, two gas exits 56, 58 were operably connected to the process chamber 10. Both the tangential gas exits 56, 58 allowed for gas to leave the process chamber 10. The reference air velocity within the process chamber 10 was approximately 208 FPM (feet per minute). The approximate particle addition was 10 particles (greater than 0.1 um) per run, and ranged from about −15 to about 48 particle additions. When comparing the experiments shown in FIG. 14 and in FIG. 15, the approximate particle addition with two tangential gas exits 56, 58 is lower (about 10 particle additions) than with a tangential gas exit 56 and standard down flow exit exhaust 50 (about 44 particles additions). Referring back to FIG. 12b, baffles within the standard down flow exhaust 50 impede the flow of gas to the standard exit 54, thus causing high system impedance and pressure. Thus, use of two tangential gas exits 56, 58 relatively increases the gas movement with the chamber and lowers the system impedance, as gas flow management is critical in achieving lower particle addition.

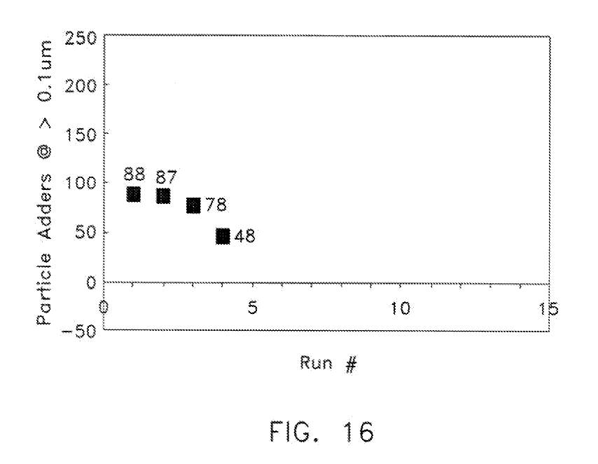

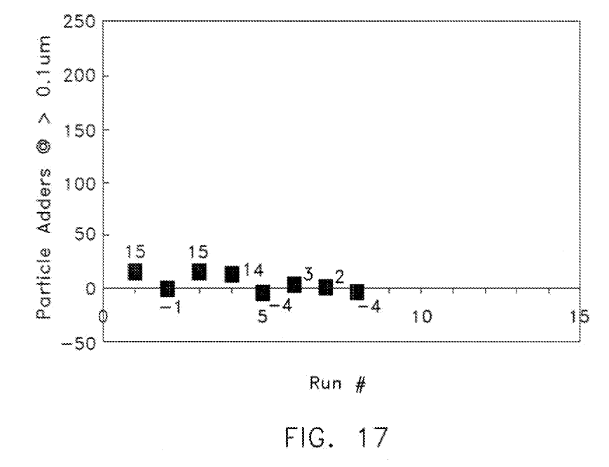

Other experiments were conducted modifying the standard exhaust 50 to remove the baffles. As can be seen in FIG. 16, a final spin was conducted within a process chamber 10 with a −0.5 in standard exhaust without baffles, and with a reference air velocity of 206 FPM. It was observed that additions ranged from approximately 48 to 88 particles, with an average of 75 particle additions per run. If was also observed that a sufficient air volume must be drawn out in order to avoid circulation inside the process chamber 10. As seen in FIG. 17, another experiment was conducted, which included a final spin within a process chamber 10 with a −1.04 in standard exhaust without baffles, and with a reference air velocity of about 150 FPM. It was observed that additions ranged from approximately −4 to 15 particles, with an average of 5 particle additions per run. If was observed there was insufficient air flow drawn out of process chamber 10.

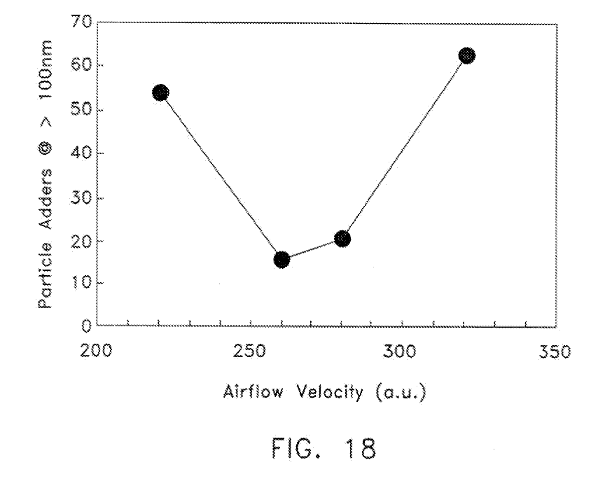

Referring next to FIG. 18, the effects of chamber exhaust, or airflow velocity, on particle performance is shown. Experiments were conducted on 300 mm wafers utilizing the HF-last process, wherein there were 6 to 8 wafers tested for each data point. At low airflow velocities, there is a potential for cross contamination due to insufficient air draw. At high airflow velocities, vortices will be created due to decreased pressure inside the process chamber. It was discovered that optimum airflow velocities are required to yield minimum particle additions. The preferred range for the chamber used and the conditions of the experiment was discovered to be between 250 and 290 cubic feet per minute. In a single wafer tool running wet processes, wafer spinning easily generates liquid aerosols. Careful attention should be given to the chamber design and airflow adjustment that provide optimal and directional airflow field to prevent turbulence near the wafer surface. Otherwise, the aerosols would deposit on sensitive wafer surface and become the source of contamination.

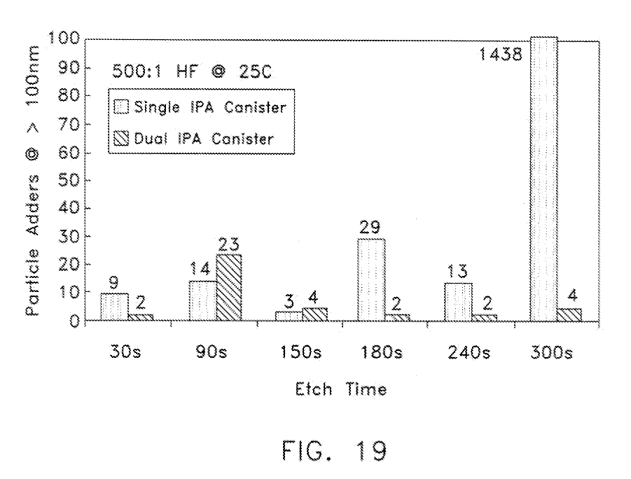

Referring to FIG. 19, experiments show the effect of IPA concentration using a single canister (bubbler) versus a dual canister (dual bubblers) in series for varying etch times on substrate particle addition greater than 100 nm. It has been found that the concentration of IPA vapor is important in achieving low particle counts on the wafer surface. The higher the concentration of IPA vapor used in the HF-last process produced wafer surfaces with relatively low particle counts. Characterized by creating low surface tension, IPA displaces the DIW from the wafer surface and thereby leaves fewer particles behind. If the water is left to evaporate (or takes longer to dry), it will leave etch by-products “silicates” behind for higher particle counts.

It has been found that high IPA vapor enhances the drying of hydrophilic wafers. This effect can be seen on planar hydrophobic wafers, where the higher the IPA concentration (through use of a dual bubbler canister as compared to a single bubbler canister) the lower the particle addition. For single IPA bubbler canisters, etch times of 180 seconds, 240 seconds and 300 seconds, produced particle additions of 29, 13 and 1438 particles, respectively. On the contrary, for double IPA bubbler canisters, etch times of 180 seconds, 240 seconds and 300 seconds, produced particle additions of 2, 2 and 4 particles, respectively.

The double canister provides about a 20% higher concentration of IPA than the single canister. It has been reported that high IPA vapor enhances the drying performance of hydrophilic wafers. Drying with IPA vapor generated through double canisters connected in series seems to yield lower particle addition. Hydrophobic wafers are extremely sensitive to the environment around them, especially during wafer spinning. More IPA enhances drying by displacing the DIW from the wafer surface more efficiently, thereby leaving fewer particles behind. This effect is highly magnified when testing patterned wafers with high aspect ratio trenches. The IPA vapor is required for displacement of water or liquids from the high aspect ratio trenches to prevent leaving residues behind.

While the drying fluid can be any number of existing drying fluids, N₂/IPA vapor is a preferred. Referring back to FIG. 1, the formation of N₂/IPA vapor achieved through the use of two bubbler canisters 42, 44 sequentially and operably aligned with one another is described. First, N₂ gas is introduced into a first bubbler canister 44 through an N₂ supply line 46. The N₂ supply line 46 is positioned within the first bubbler canister 44 and submerged in IPA liquid. The open end of the N₂ supply line 46 is positioned close to the bottom of first bubbler canister 44. The N₂ gas exits from the open end of the N₂ supply line 46 where the N₂ gas naturally forms bubbles in the IPA liquid. The N₂ bubbles rise through the IPA liquid, thereby forming N₂/IPA vapor in the open space above the IPA liquid and within the first bubbler canister 44. The N₂/IPA is then drawn into a second supply line 40, which is introduced into second bubbler canister 42.

Similar to the process involving bubbler canister 44, the second supply line 40 is positioned within the second bubbler canister 42 and submerged in IPA liquid. The open end of the second supply line 40 is positioned close to the bottom of the second bubbler canister 42, where the N₂/IPA vapor exits from the open end of the second supply line 40. The N₂/IPA vapor forms bubbles in the IPA liquid, which then rise to the top to form a highly concentrated N₂/IPA vapor. Such N₂/IPA vapor has a higher concentration of IPA compared to if only one bubbler was used. The highly concentrated N₂/IPA vapor is then drawn out of the second bubbler canister 42 through the main N₂/IPA supply line 48.

Thus, the use of a multi-canister configuration, which in one embodiment incorporates first and second bubbler canisters 42, 44, provides a stable and high concentration of N₂/IPA vapor. It has been discovered that promoting a longer exposure time between the N₂ gas and liquid IPA allows the IPA to saturate the N₂ gas before exiting into the main drying fluid supply line. Providing two canisters 42, 44 in a sequential configuration allows the N₂/IPA to reach a stable IPA concentration. It also allows the N₂/IPA vapor to have a high IPA concentration.

Hydrophobic wafers are extremely sensitive to the environment around them especially when spinning. More IPA enhances drying of the substrate surface by displacing the DIW quicker and therefore leaving fewer particles behind. This effect is highly magnified when testing high aspect ratio trenches. It is believed that higher amounts of IPA vapor will be required to displace water or liquids from these deep trenches in order to leave no residues behind.

While a number of embodiments of the current invention have been described and illustrated in detail, various alternatives and modifications will become readily apparent to those skilled in the art without departing from the spirit and scope of the invention.

What is claimed is:

1. A method of processing a substrate comprising:
a) supporting a substrate having a hydrophilic surface in a substantially horizontal orientation;
b) rotating the substrate;
c) applying a film of an aqueous solution of HF to the hydrophilic surface of the substrate for a period of time sufficient to convert the hydrophilic surface into a hydrophobic surface, wherein the concentration of HF is between about 0.1% to about 0.5% by weight of HF in water and the period of time is between about 100 and about 300 seconds;
d) applying DI water to the hydrophobic surface of the substrate; and
e) applying a drying fluid to the hydrophobic surface of the substrate so as to substantially dry the hydrophobic surface.

2. The method of claim 1 wherein the substrate is rotated at a substantially constant rotational speed during completion of steps c) through e), wherein the rotational speed is less than 400 rpm.

3. The method of claim 2 wherein the rotational speed is less than about 200 rpm.

4. The method of claim 1, wherein the DI water is degassed.

5. The method of claim 1 wherein step d) comprises applying the film of DI water to the hydrophobic surface of the substrate for between about 5 to about 20 seconds.

6. The method of claim 1 wherein the drying fluid is N₂/IPA vapor.

7. The method of claim 6 wherein the drying fluid is coupled to a drying source comprising a first bubbler and a second bubbler, wherein the second bubbler is sequentially and operably aligned to the first bubbler, the first bubbler generating N₂/IPA vapor having a first IPA concentration and coupled to the second bubbler, the second bubbler generating N₂/IPA vapor having an elevated IPA concentration greater than the first IPA concentration, and wherein the drying fluid comprises the elevated IPA concentration.

8. The method of claim 1 wherein the chamber comprises an exhaust positioned in a substantially tangential position relative to a horizontal edge of the substrate.

9. The method of claim 8 wherein airflow velocity within the chamber is between about 250 and about 280 au.

10. A method of processing a substrate comprising:
a) supporting a substrate having a hydrophilic surface in a substantially horizontal orientation;
b) rotating the substrate about a center point at a rotational speed selected to minimize particle addition on the substrate;
c) applying a film of an aqueous solution of HF having a concentration of HF to the hydrophobic surface of the substrate for a period of time, wherein the concentration of HF and the period of time are selected so that the hydrophilic surface is converted into a hydrophobic surface;
d) applying DI water to the hydrophobic surface of the substrate; and
e) applying a drying fluid to the hydrophobic surface of the substrate so as to substantially dry the hydrophobic surface, the drying fluid coupled to a drying source comprising a first bubbler and a second bubbler, wherein the second bubbler is sequentially and operably aligned to the first bubbler, the first bubbler generating N₂/IPA vapor having a first IPA concentration and coupled to the second bubbler, the second bubbler generating N₂/IPA vapor having an elevated IPA concentration greater than the first IPA concentration, and wherein the drying fluid comprises the elevated IPA concentration.

11. The method of claim 10 wherein the substrate is rotated at a substantially constant rotational speed during completion of steps c) through e), and wherein the rotational speed is less than 400 rpm.

12. The method of claim 10 wherein the period of time is between about 100 and about 300 seconds.

13. The method of claim 10 wherein the concentration of HF is between about 0.1% to about 0.5% by weight of HF in water.

14. The method of claim 10 wherein the DI water is degassed DI water and wherein step d) comprises applying the film of DI water to the hydrophobic surface of the substrate for between about 5 to about 20 seconds.

15. The method of claim 10 wherein the chamber comprises an exhaust positioned in a substantially tangential position relative to a horizontal edge of the substrate, the exhaust configured to maintain a substantially even distribution of airflow within the chamber, where airflow velocity is between about 250 and about 280 au.

16. The method of claim 10 further comprising positioning an assembly comprising a first dispenser, a second dispenser, and a third dispenser above the surface of the substrate, the first dispenser operably coupled to a source of DI water and the second and third dispensers operably coupled to a source of drying fluid, the second and third dispensers positioned on the assembly adjacent one another and spaced from the first dispenser, the second dispenser having a larger opening than the third dispenser, and the second dispenser being located between the third dispenser and the first dispenser.

17. An apparatus for processing a substrate comprising:
a chamber having at least one wall;
a rotary support member located within the chamber for supporting the substrate in a substantially horizontal position and adapted to rotate the substrate; and
a first exhaust exit located within the at least one wall, wherein the first exhaust exit is tangential to a rotational direction of the substrate.

18. The apparatus of claim 17 further comprising a second exhaust exit, wherein the second exhaust exit is parallel to the axis of rotation of the substrate.

19. The apparatus of claim 17 further comprising a second exhaust exit, wherein the first exhaust exit and the second exhaust exit are tangential to the rotational direction of the substrate.

20. The apparatus of claim 17 wherein the first exhaust exit is free of baffles.
